(19) United States
(12) Patent Application Publication
(10) Pub. No.: US 2010/0017446 A1
(43) Pub. Date: Jan. 21, 2010

(54) File system configuration method and apparatus for data security and for accessing same, and storage device accessed by same

(75) Inventors: Dae-hoon Choi, Seoul (KR); Hyung-jo Yoon, Seoul (KR); Hyun-min Cho, Cheonan-si (KR); Myung-jae Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/457,167

(22) Filed: Jun. 2, 2009

(30) Foreign Application Priority Data
Jul. 17, 2008 (KR) 10-2008-0069748

(51) Int. Cl. G06F 12/00; G06F 17/30; G06F 21/00

(52) U.S. Cl. 707/205; 726/17; 707/E17.01; 707/200

(57) ABSTRACT

Provided are a file system configuration method and apparatus for data security, a method and apparatus for accessing a data security area formed by the same, and a data storage device accessed by the same. A method of configuring a file system comprising a general area in which general data is stored and a security area in which security data is stored, in a storage device, includes generating a first file system format corresponding to the general area to store the first file system format in a buffer; generating a second file system format corresponding to the security area and storing the second file system format in the buffer so as to allow an authorized user to read data stored in the general area and not to allow the authorized user to write data to the general area when the authorized user accesses the security area; and configuring the file system of the storage device by using the first and second file system formats stored in the buffer.

### CROSS-REFERENCE TO RELATED APPLICATIONS

This application claims the priority benefit of Korean Patent Application No. 10-2008-0069748, filed on Jul. 17, 2008, in the Korean Intellectual Property Office, the disclosure of which is incorporated herein in its entirety by reference.

### BACKGROUND

1. Field

One or more embodiments relate to a data security method and apparatus, and more particularly, to a method and apparatus for configuring a data security file system having two file allocation tables (FATs) in a single partition, a method and apparatus for accessing a data security area formed by the same, and a data storage device accessed by the same.

2. Description of the Related Art

Through a Plug and Play (PnP) function of the Windows® can various files generated by using a personal computer (PC) be stored in a flash memory such as a universal serial bus (USB) memory device and transferred to other devices. Users can thereby easily access the files stored in the USB memory device.

For data security, the files can be compressed through encryption or so, or many other security solutions can be used. However, in that case, a file has to be decompressed whenever a user accesses the file, or a file has to be stored in another location before opening the file, which causes inconvenience.

### SUMMARY

One or more embodiments include a file system configuration method and apparatus for preparing two storage areas in a single partition of a USB and configuring one of the storage areas to an area accessible by using a general PnP function of a PC and the other to an area accessible only by performing user authentication, a method and apparatus for accessing a data security area formed by the same, and a data storage device accessed by the same.

According to an aspect of one or more embodiments, there may be provided a method of configuring a file system including a general area in which general data is stored and a security area in which security data is stored, in a storage device, the method including generating a first file system format corresponding to the general area to store the first file system format in a buffer; generating a second file system format corresponding to the security area and storing the second file system format in the buffer so as to allow an authorized user to read data stored in the general area and not to allow the authorized user to write data to the general area when the authorized user accesses the security area; and configuring the file system of the storage device by using the first and second file system formats stored in the buffer.

According to an aspect of one or more embodiments, there may be provided a method of accessing a security area of a storage device including a general area in which general data is stored and the security area in which security data is stored, the method including authenticating a user to access the security area, reading an offset for jumping from the general area to the security area, and jumping to the security area; reading data stored in the general area from the security area and setting a FAT of the security area so as to prevent data from being written to the general area; and setting a reserved root cluster of the security area to be linked to a root cluster of the general area.

According to an aspect of one or more embodiments, there may be provided an apparatus for setting a general area in which general data is stored and a security area in which security data is stored, in a storage device, the apparatus including an input unit receiving information on capacities of the general and security areas; a buffer; and a control unit generating a first file system format corresponding to the general area to store the first file system format in the buffer, generating a second file system format corresponding to the security area to store the second file system format in the buffer so as to allow an authorized user to read data stored in the general area and not to allow the authorized user to write data to the general area when the authorized user accesses the security area, and configuring a file system of the storage device by using the first and second file system formats stored in the buffer.

According to an aspect of one or more embodiments, there may be provided an apparatus for accessing a security area of a storage device including a general area in which general data is stored and the security area in which security data is stored, the apparatus including an input unit receiving user authentication information; a control unit calculating an offset for jumping to the security area from header information of the general area, obtaining a reserved root directory from header information of the security area, connecting a root directory of the general area to the reserved root directory of the security area; a disk driver jumping a physical address of the general area to a physical address of the security area by using the offset; and a file system driver reading data stored in the general area from the security area and managing a file list of the general area so as to prevent data from being written to the general area.

According to an aspect of one or more embodiments, there may be provided a storage device including a general area in which general data is stored and a security area in which security data is stored, the storage device including a file system; wherein the file system is configured by generating a first file system format corresponding to the general area to store the first file system format in a buffer, generating a second file system format corresponding to the security area and storing the second file system format in the buffer so as to allow an authorized user to read data stored in the general area and not to allow the authorized user to write data to the general area when the authorized user accesses the security area and configuring the file system of the storage device by using the first and second file system formats stored in the buffer.

### BRIEF DESCRIPTION OF THE DRAWINGS

These and/or other aspects will become apparent and more readily appreciated from the following description of one or more embodiments, taken in conjunction with the accompanying drawings of which:

FIG. 1 illustrates a configuration of a general file allocation table 32 (FAT32) file system;

FIG. 2 illustrates a schematic configuration of an external storage device and a PC performing a data security method according to an embodiment;

FIG. 3 illustrates a flowchart of an external storage device formatting method for data security, according to an embodiment;

FIG. 4 illustrates a configuration of a FAT32 file system set by the external storage device formatting method illustrated in FIG. 3;

FIG. 5 illustrates a process of accessing a security area in the FAT32 file system illustrated in FIG. 4;

FIG. 6 illustrates a flowchart of a method of accessing a security area, according to an embodiment;

FIG. 7A illustrates a result of which Windows® search is executed in a PC when a user is authenticated in accessing the security area; and

FIG. 7B illustrates a result of which Windows® search is executed when a user is not authenticated in accessing the security area.

### DETAILED DESCRIPTION

Reference will now be made in detail to embodiments, examples of which are illustrated in the accompanying drawings, wherein like reference numerals refer to the like elements throughout. Embodiments are described below to explain aspects of embodiments by referring to the figures.

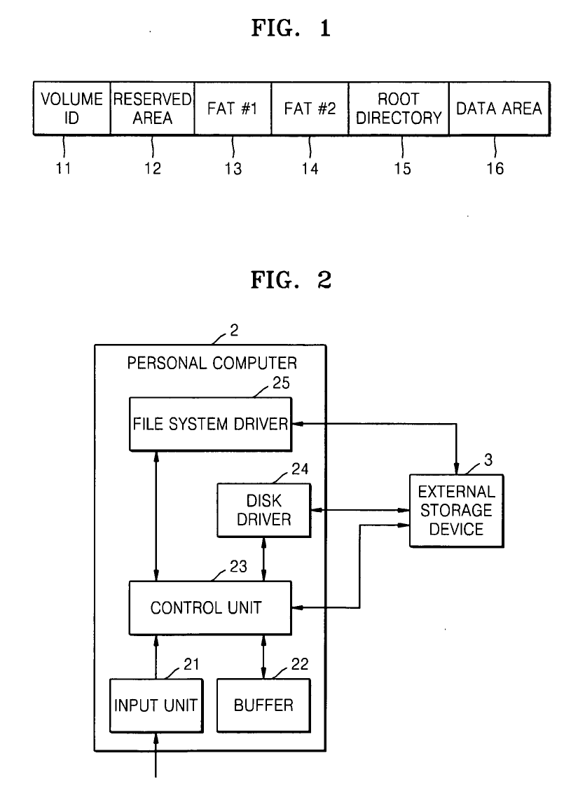

FIG. 1 illustrates a configuration of a general file allocation table 32 (FAT32) file system.

Referring to FIG. 1, the FAT32 file system includes a volume identification (ID) 11, a reserved area 12, a first file allocation table (FAT#1) 13, a second FAT (FAT#2) 14, a root directory 15, and a data area 16.

The Windows® accesses and manages file data by using the illustrated structure. In the FAT32 file system, the volume ID 11 contains information such as an overall size of a storage space of the FAT32 file system, locations and sizes of the first and second FATs 13 and 14, the number of sectors per cluster, and a location of the root directory 15 of a USB storage device, when the USB storage device is connected to a PC. The reserved area 12 is reserved for additional information in the future. The first FAT 13 contains locations of files and directories in a single linked list type and provides information for linking a plurality of clusters. The second FAT 14 is a backup area of the first FAT 13. The root directory 15 contains information on a location of a root directory. The data area 16 stores the files and directories in a unit of cluster.

When the USB storage device is connected to the Windows®, the Windows® reads the overall size of the storage space from the volume ID 11, the locations of the files or the directories from the FAT#1 13, and the root directory location from the root directory 15 of the FAT32 file system. The Windows® reads a location of a cluster including the root directory 15 from the FAT#1 13, and shows the read location of the cluster on Windows® search through a list of files and directories stored in the root directory 15.

If a user requests to access a specific file, the Windows® transmits a logic address of the specific file to a USB disk driver through a file system driver located on a kernel, and the USB disk driver converts the logic address into a physical address. The Windows® accesses the data area 16 of the FAT32 file system by using the physical address.

A plug and play (PnP) function of the Windows® has a large number of security problems. A mobile storage device such as the USB storage device can be accessed by anyone without any user authentication immediately after being connected to a personal computer (PC). Thus, if private information of individuals or security data of enterprises or government offices are stored in the mobile storage device, anyone who obtains the mobile storage device can access data stored therein.

In order to enhance file security, a file can be encrypted. In this case, not only a user experiences inconvenience when trying to access the file, but other people can access the file if an encryption key of the file is exposed. As another way of the file security enhancement, access to a storage device can be restricted by partitioning storage area and allowing the access through a user authentication. However, in this case, data can be easily accessed by using a forensic technique in which data is collected, analyzed, and restored.

Accordingly, it is necessary to block unauthorized users fundamentally from accessing a data security area.

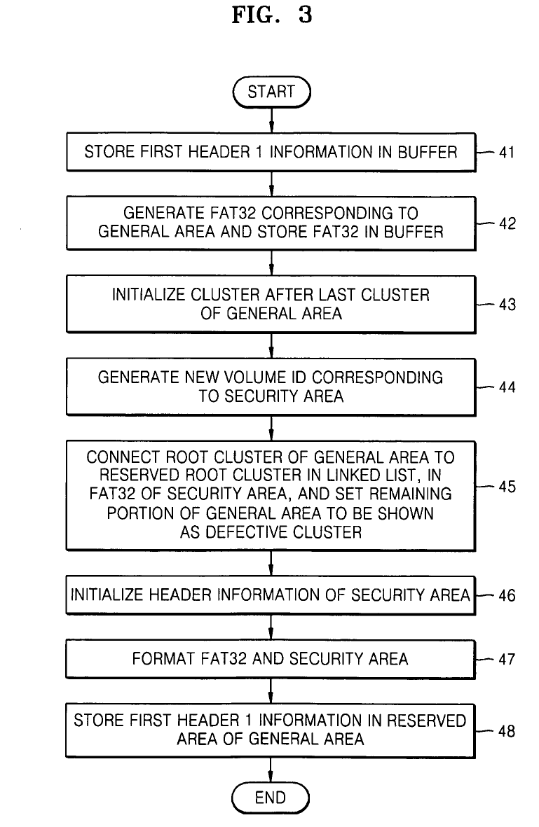

FIG. 2 illustrates a schematic configuration of an external storage device and a PC performing a data security according to an embodiment.

Referring to FIG. 2, the PC 2 includes an input unit 21, a buffer 22, a control unit 23, a disk driver 24, and a file system driver 25.

The input unit 21 receives data required to separate a general area and a security area set in the external storage device 3 from a user.

The control unit 23 executes an application for data security, and the disk driver 24 and the file system driver 25 perform operations required when the user accesses the security area set in the external storage device 3.

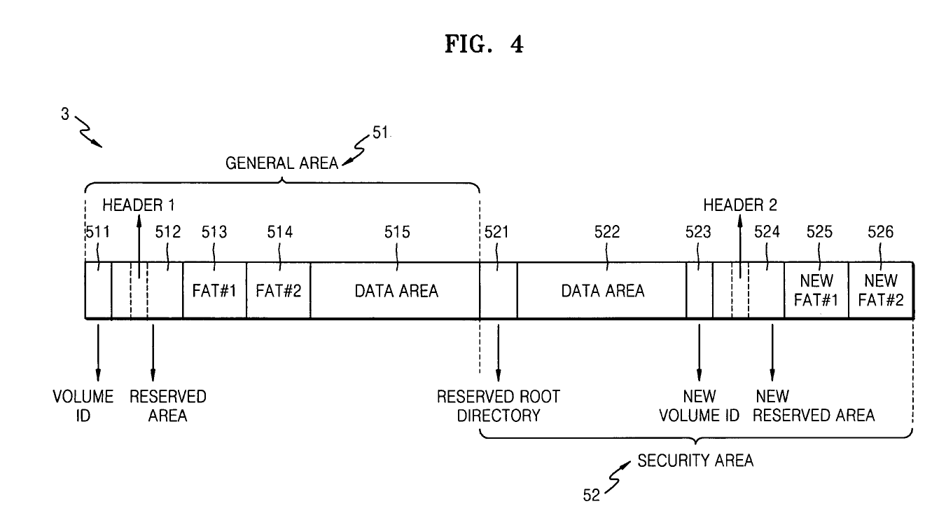

FIG. 3 illustrates a flowchart of an external storage device formatting method for data security, according to an embodiment. FIG. 3 will be described in conjunction with FIG. 2.

Referring to FIG. 3, when a user executes an application for setting a security area and inputs information such as authentication information and information on the capacity of the security area through the input unit 21, the control unit 23 generates first header information including the authentication information and location information of a general area and the security area, and stores the first header information in the buffer 22, in operation 41.

Then, the control unit 23 generates a FAT32 format corresponding to the general area and stores the FAT32 format in the buffer 22, in operation 42. In this case, the size of the FAT32 corresponds to an overall size of the external storage device 3.

In addition, the control unit 23 initializes a cluster after the last cluster of the general area as 0x00 in order to use the cluster after the last cluster of the general area as a reserved root directory, in operation 43.

Then, the control unit 23 generates a new volume identification (ID) corresponding to the security area, in operation 44. In this case, the new volume ID is generated with regard to the overall size of the external storage device 3 such that the general area is also accessible.

The control unit 23 connects a root cluster of the general area to a reserved root cluster of the security area in a linked list in a FAT32 to be used in the security area, and sets a portion representing clusters of the general area, except for the root cluster, to 0x01, in operation 45. As such, the Windows® recognizes the portion set to 0x01 as defective clusters and thus data is prevented from being written to the general area when the Windows® accesses the security area later.

Then, the control unit 23 initializes second header information including information on the reserved root cluster of the security area, as 0x00 in operation 46. The FAT32 of the security area and the FAT32 of the general area are stored in the buffer 22. Thus, the external storage device 3 is formatted by reading the FAT32 of the security area and the FAT32 of the general area which are stored in the buffer 22, in operation 47. In this case, the FAT32 of the security area is encrypted by the disk driver 24.

The first header information is written to the reserved area of the general area in operation 48.

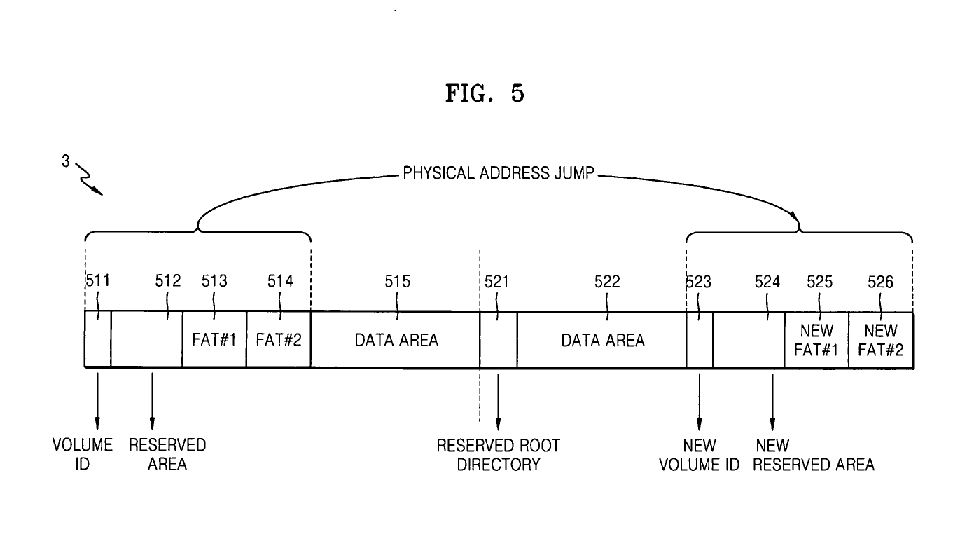

FIG. 4 illustrates a configuration of the FAT32 file system set by the external storage device formatting method illustrated in FIG. 3.

Referring to FIG. 4, the FAT32 file system includes a general area 51 and a security area 52.

As the FAT32 file system illustrated in FIG. 1, the general area 51 includes a volume ID 511, a reserved area 512, a first FAT(FAT#1) 513, a second FAT(FAT#2) 514, and a data area 515. The first header information generated in operation 41 illustrated in FIG. 3 is stored in the reserved area 512.

The security area 52 includes a reserved root directory 521, a data area 522, a new volume ID 523, a new reserved area 524, a new FAT#1 525, and a new FAT#2 526. The second header information generated in operation 46 illustrated in FIG. 3 is stored in the new reserved area 524.

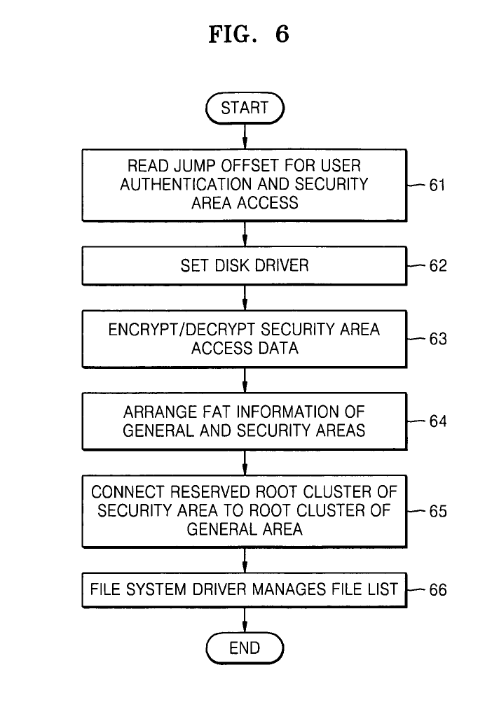

When the security area 52 is set as in FIG. 5, the Windows® manipulates a volume ID as if a storage device has a smaller capacity than an actual capacity, reconfigures a FAT corresponding to the manipulated volume ID so as to configure a FAT32 of the general area 51, and configures a FAT32 of the security area 52 so as to correspond to the actual capacity excluding the smaller capacity. That is, two file systems are generated in a single partition. As such, a general PC can access only the FAT32 of the general area 51 and cannot access the FAT32 of the security area 52. Thus, a disk driver may access the FAT32 of the security area 52 by jumping a physical address of a device that requests to access the FAT32 of the general area 51 from the general area 51 to the security area 52, as illustrated in FIG. 5.

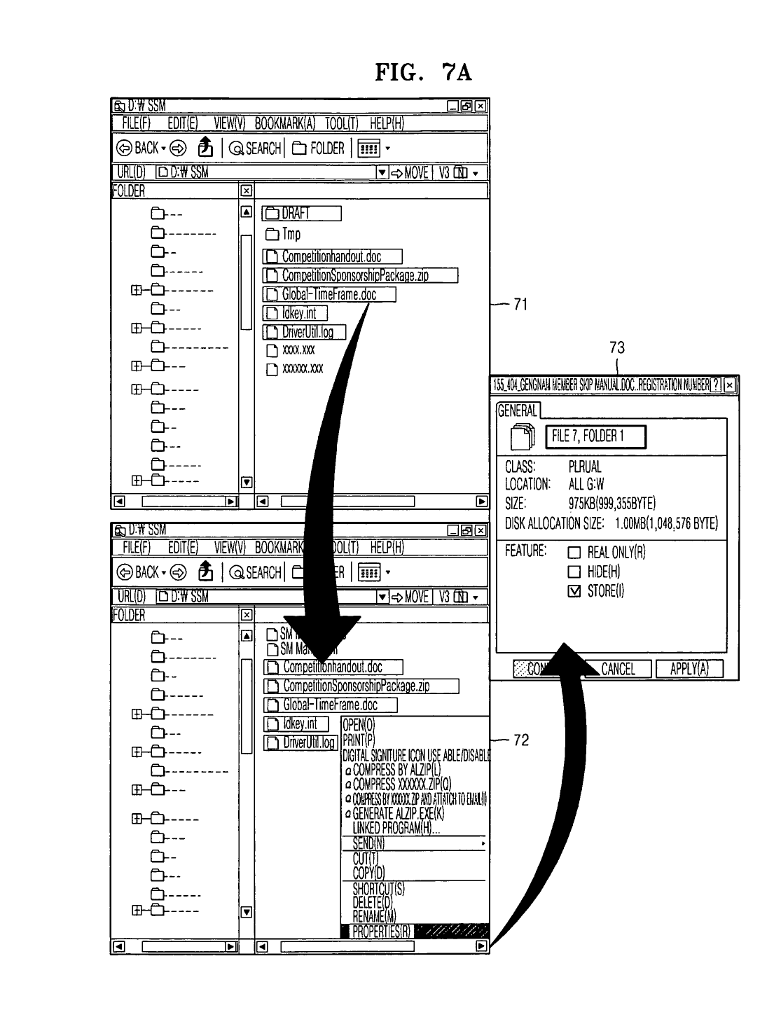

FIG. 6 illustrates a flowchart of a method of accessing a security area, according to an embodiment.

Referring to FIG. 6, when a user desires to access the security area 52 and to read or write data, the control unit 23 authenticates the user by using first header information, reads information on an overall size of a storage device from the first header information, and calculates an offset for jumping to the security area 52, in operation 61.

When the disk driver 24 is requested by the control unit 23 to read a physical address corresponding to FAT#2 514 from the volume ID 511, the disk driver 24 is set to manipulate the physical address by the offset and to output the manipulated physical address, in operation 62. Also, the disk driver 24 encrypts/decrypts all data accessing the security area 52, in operation 63.

Then, the control unit 23 overwrites the FAT information of the general area 51 to a portion set as defective clusters in an FAT of the security area 52 and sets a portion set as 0x00 in the general area FAT to 0x01, in operation 64. As such, when the user accesses the security area 52, the user may read data stored in the general area 51 and cannot write data to the general area 51.

Then, the reserved root cluster of the security area 52 is reconfigured so as to be linked to the root cluster of the general area 51, and information on the reserved root cluster is recorded as the second header, in operation 65. The information recorded as the second header is used as location information of the reconfigured root cluster when the security area 52 is re-accessed. Then, the external storage device 3 is refreshed and the file system driver 25 manages a file list of the general area 51 in order to prevent data of the general area 51 from being modified, in operation 66.

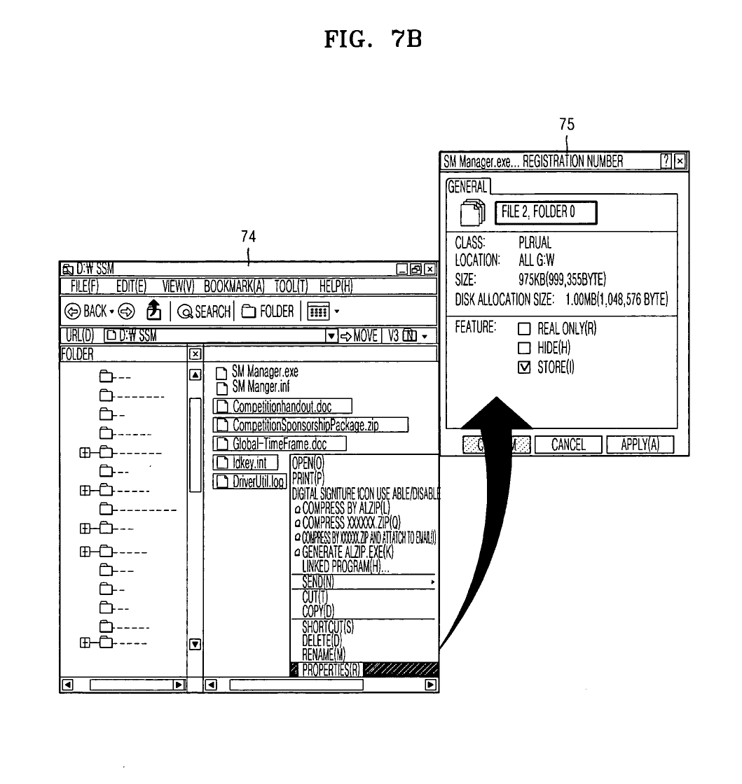

FIG. 7A illustrates a result of which the Windows® search is executed in a PC when a user is authenticated in accessing the security area.

Referring to FIG. 7A, reference number 71 shows files which can be seen on the user-authenticated PC. Reference number 72 shows files in the external storage device 5. Reference number 73 indicates a search result by the Windows® search in the user PC. As shown in FIG. 7A through 7C, all files stored in the external storage device are shown to the authorized user.

FIG. 7B illustrates a result of which the Windows® search is executed in a PC when a user is not authenticated in accessing the security area.

Referring to FIG. 7B, reference number 74 shows files which can be seen on the user-authenticated PC in accessing the external storage device. Reference 75 illustrates a search result of which the Windows® search is executed in a PC when the user is not authenticated.

When FIG. 7B is compared with FIG. 7A, the files stored in the security area are not shown to the unauthorized user.

As described above, unlike existing file security methods in which file access is blocked by encrypting files and access is allowed by performing authentication, according to one or more of the above embodiments, a security area is out of a file system managed by the Windows® OS and thus the security area is not shown in a normal state. In more detail, a file system for hiding security files exists and thus those security files may not be shown in the normal state. Also, information on partitions does not exist and thus the Windows® may not recognize a hidden file system. Accordingly, security may be further enhanced.

In addition, other embodiments can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs). The media may also be a distributed network, so that the computer readable code is stored/transferred and executed in a distributed fashion. Furthermore, the processing element could include a processor or a computer processor, and processing elements may be distributed and/or included in a single device.

In alternative embodiments, hard-wired circuitry may be used in place of or in combination with processor/controller programmed with computer software instructions to implement one or more embodiments. Thus embodiments are not limited to any specific combination of hardware circuitry and software.

Although a few embodiments have been shown and described, it would be appreciated by those skilled in the art that changes may be made in these embodiments without departing from the principles and spirit of invention, the scope of which is defined in the claims and their equivalents.

What is claimed is:

1. A method of configuring a file system comprising a general area in which general data is stored and a security area in which security data is stored, in a storage device, the method comprising:
generating a first file system format corresponding to the general area to store the first file system format in a buffer;
generating a second file system format corresponding to the security area and storing the second file system format in the buffer so as to allow an authorized user to read data stored in the general area and not to allow the authorized user to write data to the general area when the authorized user accesses the security area; and
configuring the file system of the storage device by using the first and second file system formats stored in the buffer.

2. The method of claim 1, wherein a size of a file allocation table (FAT) is set to correspond to an overall size of the storage device, in the first file system format.

3. The method of claim 2, wherein a volume identification (ID) is generated with regard to an overall size of the storage device such that the general area is also accessible, in the second file system format.

4. The method of 2, wherein the generating of the second file system format comprises:
connecting a root cluster of the general area to a reserved root cluster of the security area in the FAT of the security area; and
setting a portion of the general area, except for the root cluster, to be shown as defective clusters so as to prevent data from being written in the general area.

5. The method of claim 1, wherein a volume identification (ID) is generated with regard to an overall size of the storage device such that the general area is also accessible, in the second file system format.

6. The method of claim 1, wherein the generating of the second file system format comprises:
connecting a root cluster of the general area to a reserved root cluster of the security area in a file allocation table FAT of the security area; and
setting a portion of the general area, except for the root cluster, to be shown as defective clusters so as to prevent data from being written in the general area.

7. The method of claim 1, wherein a cluster after a last cluster of the general area is set as a reserved root directory of the security area.

8. The method of claim 1, further comprising generating user authentication information to authenticate a user and location information of the general and security areas as header information and storing the header information in a reserved area of the general area.

9. A method of accessing a security area of a storage device comprising a general area in which general data is stored and the security area in which security data is stored, the method comprising:
authenticating a user to access the security area, reading an offset for jumping from the general area to the security area, and jumping to the security area;
reading data stored in the general area from the security area and setting a file allocation table (FAT) of the security area so as to prevent data from being written to the general area; and
setting a reserved root cluster of the security area to be linked to a root cluster of the general area.

10. The method of claim 9, wherein information on the reserved root cluster is recorded in header information of the security area and location information of the reserved root cluster of the security area is provided when the security area is re-accessed.

11. The method of claim 9, wherein the setting of the FAT of the security area comprises:
overwriting an FAT of the general area to a portion set as defective cluster in the security area; and
setting an initialized portion of the FAT of the general area as defective clusters.

12. An apparatus for setting a general area in which general data is stored and a security area in which security data is stored, in a storage device, the apparatus comprising:
an input unit to receive information on capacities of the general and security areas;
a buffer; and
a control unit to generate a first file system format corresponding to the general area to store the first file system format in the buffer, generate a second file system format corresponding to the security area to store the second file system format in the buffer so as to allow an authorized user to read data stored in the general area and not to allow the authorized user to write data to the general area when the authorized user accesses the security area, and configure a file system of the storage device by using the first and second file system formats stored in the buffer.

13. An apparatus for accessing a security area of a storage device comprising a general area in which general data is stored and the security area in which security data is stored, the apparatus comprising:
an input unit to receive user authentication information;
a control unit to calculate an offset for jumping to the security area from header information of the general area, obtain a reserved root directory from header information of the security area, and connect a root directory of the general area to the reserved root directory of the security area;
a disk driver to jump a physical address of the general area to a physical address of the security area by using the offset; and
a file system driver to read data stored in the general area from the security area and to manage a file list of the general area so as to prevent data from being written to the general area.

14. A storage device comprising a general area in which general data is stored and a security area in which security data is stored, the storage device comprising:
a file system;
wherein the file system is configured by
generating a first file system format corresponding to the general area to store the first file system format in a buffer;
generating a second file system format corresponding to the security area and storing the second file system format in the buffer so as to allow an authorized user to read data stored in the general area and not to allow the authorized user to write data to the general area when the authorized user accesses the security area; and
configuring the file system of the storage device by using the first and second file system formats stored in the buffer.

15. The storage device of claim 14,
wherein the second file system format is generated by connecting a root cluster of the general area to a reserved root cluster of the security area in a file allocation table (FAT) of the security area and setting a portion of the general area, except for the root cluster, to be shown as defective clusters so as to prevent data from being written in the general area.

16. The storage device of claim 14, wherein a cluster after a last cluster of the general area is set as a reserved root directory of the security area.

17. The storage device of claim 14, wherein user authentication information to authenticate a user and location information of the general and security areas are generated as header information and are stored in a reserved area of the general area.
